(19) United States
(12) Patent Application Publication
(10) Pub. No.: US 2004/0110615 A1
(43) Pub. Date: Jun. 10, 2004

(54) Large size flange machining device

(76) Inventor: Chen Sung Tan, Kaohsiung Hsien (TW)

Correspondence Address: Leong C. Lei, PMB #1008, 1867 Ygnacio Valley Rd., Walnut Creek, CA, 94598-3214, US

(21) Appl. No.: 10/374,425

(22) Filed: Feb. 27, 2003

(30) Foreign Application Priority Data
Dec. 9, 2002 (TW) 091219906

(51) Int. Cl. B23Q 3/157

(52) U.S. Cl. 483/55

(57) ABSTRACT

A large size flange-machining device is disclosed. The device is the rear side of the seat is provided with a protruded platform and the top of the platform is disposed with a sliding seat, and the sliding seat is provided with a blade platform which can move horizontally on the sliding seat, a blade seat is disposed on the blade platform and the blade seat can move up and down on the blade platform.

### BACKGROUND OF THE INVENTION

(a) Technical Field of the Invention

The present invention relates to a machining device, and in particular, a device employing a platform which can be rotated together with the machining member.

(b) Description of the Prior Art

FIG. 1 is a conventional planing machine used in machining tools. As shown in FIG. 1, the machine is a seat 11 having a working platform 12 on the upper portion. The working platform 12 can move forward or backward on the seat 11. The upper portion of the working platform 12 is provided with a sliding seat 13 horizontally. A blade platform 14 is provided on the sliding seat 13, and the blade platform 14 can move left or right by means of a screw rod 131 of the blade platform 14. A blade seat 15 is mounted on the blade platform 14 and the blade seat 15 can move up and down on the blade platform 14, and the bottom end head of the blade seat 15 is provided with blade. In the process of machining, circular machining member is mounted on the working platform 12 and let the working platform 12 to move forward so that the machining member moves to the lower section of the blade seat 15. Next, the blade platform 14 is triggered to move horizontally and the blade at the bottom of the blade seat 15 will face the machining member, and then the blade seat 15 moves downward by the blade platform 14.

The conventional device required a larger area for the machining member in the course of machining and procedures of the machining are complicated. Besides, it is not convenient in replacement of machining blades.

### SUMMARY OF THE INVENTION

Accordingly, it is an object of the present invention to provide a larger size flange machining device, the rear side of the seat is provided with a protruded platform and the top of the platform is disposed with a sliding seat, and the sliding seat is provided with a blade platform which can move horizontally on the sliding seat, a blade seat is disposed on the blade platform and the blade seat can move up and down on the blade platform.

It is a further object of the present invention to provide a larger size flange-machining device, wherein the bottom side of the machining plate is provided with a plurality of spaced apart support pillars and bearings are disposed between the support pillars and the machining plate.

It is yet another object of the present invention to provide a larger size flange machining device, wherein one side of the sliding seat is a blade storage and the interior of the blade storage is provided with a circular blade rim, and the circumferential edge of the rim is provided with a plurality of spaced apart notches for the positioning of blades of various sizes and types.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional planing machine.

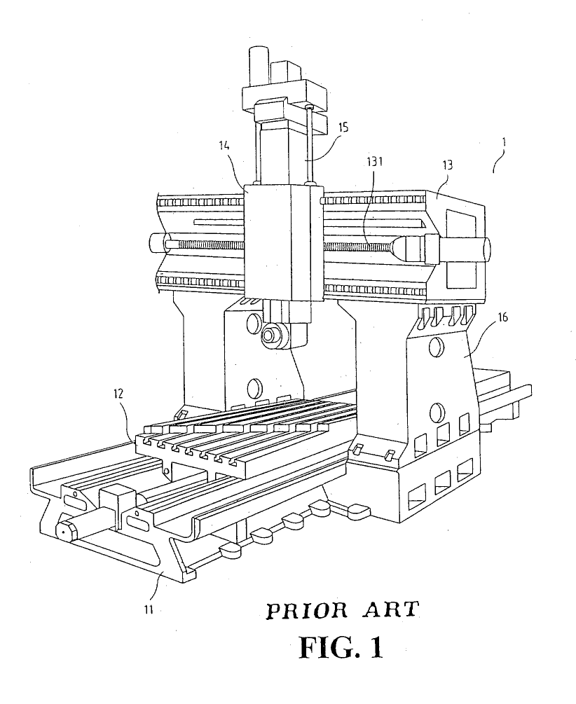

FIG. 2 is a perspective view of a preferred embodiment of the present invention.

FIG. 3 is a perspective view from a side elevation of the present invention.

FIG. 4 is a perspective view of a clip of the present invention.

FIG. 5 is a schematic view showing the action of the clip of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

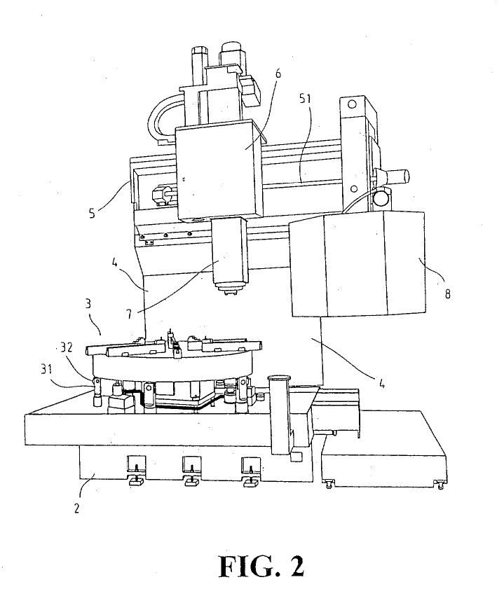

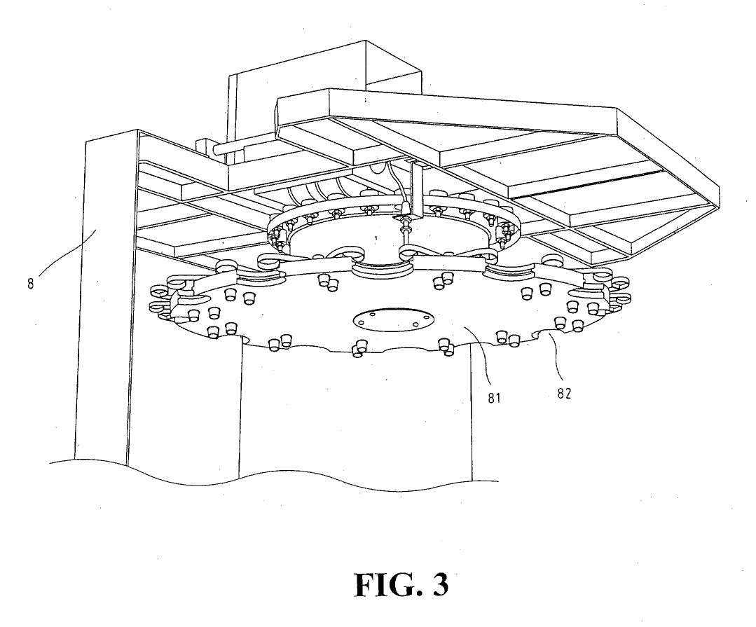

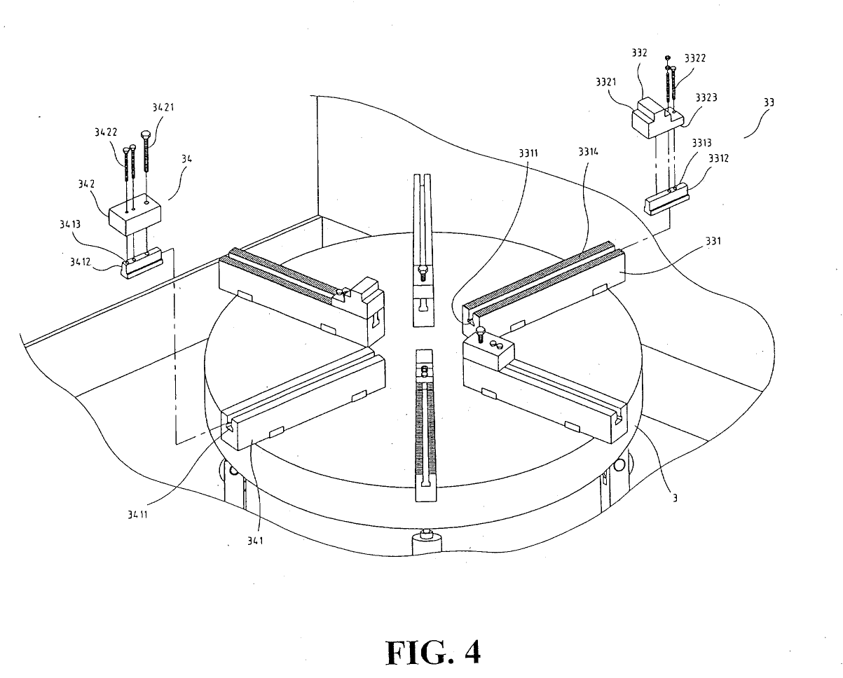

Referring to FIG. 2, there is shown an improved structure of a flange-machining device having a seat 2, wherein the top thereof is provided with a circular machining plate 3. The machining plate 3 can be driven to rotate, and the bottom side of the machining plate 3 is provided with a plurality of support pillars 31. There are bearing 32 positioned between the support pillars 31 and the machining plate 3, allowing the machining plate 3 to rotate smoothly. The rear side of the seat 2 is provided with an erect pillar 4 having a top portion provided with a sliding seat 5. A screw rod 51 is disposed on the sliding seat 5 and is mounted with a blade platform 6 such that the platform 6 can rotate by utilizing the screw rod 51. The sliding seat moves horizontally, and the blade platform 6 is mounted with a blade seat 7 such that the blade seat 7 can move up or down on the blade platform 6. The blade seat 7 is corresponding to the machining plate 3. In addition, one side edge of the sliding seat 5 is provided with a blade storage 8. Referring to FIG. 3, the interior of the blade storage 8 is mounted with a circular blade rim 81. The circumferential edge of the rim 81 is provided with a plurality of spaced apart notches 82 for the positioning of different sizes and types of blades. Next, referring to FIG. 4, the upper end face of the machining plate 3 is alternately arranged with clips 33, 34 which are radially arranged. The clip 33 comprises a rail 331 and a clipping block 332. The upper end face of the rail 331 is provided with a passage 3311. The passage 3311 is mounted with a position block 3312 and the position block 3312 is provided with a screw hole 3313. The end face of the two lateral side of the passage 3311 is provided with thread 3314. The front-end head of the clipping block 332 is provided with a L-shaped support face 3321, and the rear side of the block 332 is disposed with a screwing element 3322, and the bottom face thereof is provided with threads 3323. In addition, the clip 34 includes a rail 341 and a support block 342, and the upper end of the rail 341 is provided with a depression at the center to adapt to the position block 3412. The position block 3412 is provided with screw hole 3413 and the front end of the support block 342 is disposed with a support screw 3421 which can be rotated up and down. The rear side is provided with a screw-fastening element 3422.

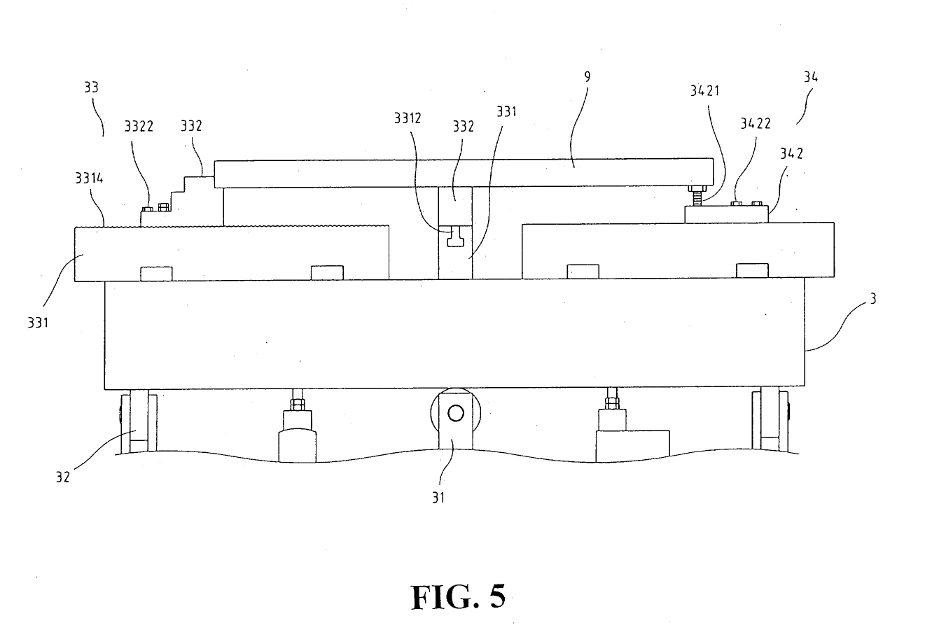

Referring to FIG. 5, there is shown the positioning of a machining member 9. The support screw 3421 is rotated to a position higher than the support face 3321 of the clip 33. Next, the support block 342 moves forward to an appropriate position along the rail 341 and the circumference formed by the individual support blocks 342 is slightly smaller than the external diameter of the machining member 9, and the fastening element 3422 is used to fasten the support block 342. The machining member 9 is placed down to the support block 342, and the support screw 3421 urges the machining member 9 to form a suspension state. Next, the clipping block 332 moves forward along the rail 331 until the support face 3321 of the clip 33 is contact the circumferential face of the machining member 9 and the fastening element 3322 is used to position the clipping block 332, and by means of the engagement of the gear 3423 at the bottom side of the clipping block 342 and the threads 3314 of the rail 331, the clipping block 332 is secured to become stable. By lowering the support screw 3421, the machining member 9 urges the support face 3321 of the individual clipping block 332 to support so as to proceed to subsequent machining process.

Due to the fact that the blade platform 6 can move horizontally, the blade platform 6 moves to the blade storage 8 direction and the upper portion of the machining plate 3 becomes an open space, which will not block loading and unloading work and the machining member can be fixed to the machining plate 3. Next, the blade platform 6 moves horizontally so that the blade seat 7 and the machining plate 3 faces each other, and after the blade seat 7 moves downward, the bottom side of the blade seat 7 is proceeded to machine the machining member on the machining plate 3. As the machining plate 3 can be driven to rotate, the machining plate 3 is rotated in the course of machining and the blade seat 7 is driven to move horizontally by the blade platform. In addition, one side of the sliding seat 5 is provided with the blade storage 8 and the rear side of the blade storage 8 holds the blade rims 81 which hold blades of various shapes and sizes.

Thus, if a blade is to be replaced, the blade platform 6 drives the blade seat 7 to move to the side of the blade storage 8 and an appropriate blade is obtained from the blade rim 81 and time is thus saved, and thus the cost of production is reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A machining device having a machine seat and a machining plate, and the machining plate being driven by the rotation at the bottom of the blade seat, and the machining plate provided with alternately arranged clips, and the clips radially arranged for the positioning of the machining member, characterized in that the rear side of the seat is provided with a protruded platform and the top of the platform is disposed with a sliding seat, and the sliding seat is provided with a blade platform which can move horizontally on the sliding seat, a blade seat is disposed on the blade platform and the blade seat can move up and down on the blade platform.

2. The machining device of claim 1, wherein the bottom side of the machining plate is provided with a plurality of spaced apart support pillars and bearings are disposed between the support pillars and the machining plate.

3. The machining device of claim 1, wherein one side of the sliding seat is a blade storage and the interior of the blade storage is provided with a circular blade rim, and the circumferential edge of the rim is provided with a plurality of spaced apart notches for the positioning of blades of various sizes and types.
